(19) United States
(12) Patent Application Publication
(10) Pub. No.: US 2026/0192878 A1
(43) Pub. Date: Jul. 9, 2026

(54) FOLDING BICYCLE

(71) Applicant: Xiaoliang XU, Zhejiang (CN)

(72) Inventor: Xiaoliang XU, Zhejiang (CN)

(73) Assignee: Xiaoliang XU, Zhejiang (CN)

(21) Appl. No.: 19/557,053

(22) Filed: Mar. 4, 2026

Related U.S. Application Data
(63) Continuation of application No. PCT/CN2024/115702, filed on Aug. 30, 2024.

(30) Foreign Application Priority Data
Sep. 5, 2023 (CN) 202322397583.3
Nov. 22, 2023 (CN) 202323149355.0

(51) Int. Cl. B62K 15/00; B62B 3/02; B62J 1/08; B62J 7/04; B62K 3/02; B62K 21/26

(52) U.S. Cl. CPC B62K 15/008; B62J 1/08; B62J 7/04; B62K 3/02; B62K 21/26; B62B 3/02

(57) ABSTRACT

A folding bicycle includes a frame beam, where the frame beam connects a front wheel frame and a rear wheel frame at both ends, a front wheel is mounted on the front wheel frame, and a rear wheel is mounted on the rear wheel frame; two folding mechanisms are disposed on the frame beam, and the frame beam is configured to be folded into three sections through the two folding mechanisms; when the rear wheel frame drives the rear wheel to flip vertically forward, the frame beam is folded through the folding mechanisms, and by adjusting a folding angle, the front wheel and the rear wheel are brought into a parallel state; and one of the two folding mechanisms is disposed on one side of a front portion of the frame beam, and the other is disposed on the other side of a rear portion of the frame beam.

### CROSS-REFERENCE TO RELATED APPLICATION

This application is a continuation of international application of PCT application Ser. No. PCT/CN2024/115702 filed on Aug. 30, 2024, which claims the priority benefit of China application serial no. 202322397583.3, filed on Sep. 5, 2023, and China application serial no. 202323149355.0, filed on Nov. 22, 2023. The entirety of the above-mentioned patent application is hereby incorporated by reference herein and made a part of this specification.

### TECHNICAL FIELD

The present disclosure relates to the technical field of vehicles, and in particular to a folding bicycle.

### BACKGROUND

As urban traffic becomes increasingly congested and vehicle exhaust emissions rise daily, people are increasingly inclined to use lightweight and environmentally friendly means of transportation. Moreover, with the improvement of people's living standards and the accelerated pace of work and life, especially the fast-paced life in first-tier cities, people usually use mopeds as a means of commuting to adapt to this fast-paced life. Due to their portability, environmental friendliness, and many other advantages, moped vehicles typically include bicycles, tricycles, scooters, trolleys, and other related vehicles.

Among them, folding bicycles are becoming increasingly popular, and various brands and models of folding bicycles have emerged in the market. Folding bicycles are mainly divided into two major types in terms of folding methods: horizontal folding and vertical folding. Both types of folding methods have their own advantages and disadvantages. The horizontal folding structure is simple, the technology is mature, and the operation is convenient, but the volume after folding is not very compact. The vertical folding mechanism is relatively slightly more complex, but once folded, the bicycle has a relatively compact volume, and typically exhibits advantages in terms of length, width, and height dimensions. However, up to now, whether for horizontal or vertical folding bicycles, front and rear wheels are not parallel after folding, making it impossible to achieve the function of being pushed directly relying on the original two wheels after folding. Most bicycles can only be pushed for short distances by lifting the wheel on one side and relying on the single wheel on the other side to touch the ground, which is very inconvenient to operate. Alternatively, some bicycles require the installation of additional brackets and easy wheels for pushing, which adds many mechanisms and accessories, and also increases the weight and cost.

In addition, for the convenience of carrying the bicycle, the bicycle is usually designed to be foldable. As an important component of the bicycle, a handlebar also has many structures for folding design. Currently, existing folding handlebars are still inconvenient to fold, the folding process is relatively complex, both folding and restoring are troublesome, and individual folding handlebars are prone to rebounding in the folded state or wobbling in the use state.

### SUMMARY

In view of the above problems, the present disclosure aims to provide a folding bicycle characterized by convenient folding operation and ease of use.

To solve the technical problems, the present disclosure employs the following technical solution:

A folding bicycle includes a frame beam, where the frame beam connects a front wheel frame and a rear wheel frame at both ends, a front wheel is mounted on the front wheel frame, and a rear wheel is mounted on the rear wheel frame; two folding mechanisms are disposed on the frame beam, and the frame beam is configured to be folded into three sections through the two folding mechanisms; when the rear wheel frame drives the rear wheel to flip vertically forward, the frame beam is folded through the folding mechanisms, and by adjusting a folding angle, the front wheel and the rear wheel are brought into a parallel state; and one of the two folding mechanisms is disposed on one side of a front portion of the frame beam, and the other is disposed on the other side of a rear portion of the frame beam.

A loading platform is disposed on the rear wheel frame, the loading platform is mounted cooperatively with a seatpost fixing base through a steering shaft sleeve, and the loading platform is rotatable through the steering shaft sleeve.

Hinges of the two folding mechanisms are limiting hinges.

The frame beam forms a Z-shaped structure after being folded through the two folding mechanisms, and by adjusting the folding angle, the front wheel and the rear wheel are brought into a parallel state; when the frame beam is folded into the Z-shaped structure, an upper portion of the frame beam forms a loading surface, and an upper portion of the loading surface is configured to mate with a loading portion; and a Z-shaped fold may be formed, such that the frame beam forms a cargo frame platform, and moreover, the front wheel and the rear wheel are kept parallel and at the same height at a plurality of positions, thereby providing a basic structure for transforming the bicycle into a small trolley, a camping table, or other utility forms.

A platform rack is also disposed on the front wheel frame.

By adjusting the folding angle after the frame beam is folded through the two folding mechanisms, a distance between the front wheel and the rear wheel is adjusted, the front wheel and the rear wheel are kept parallel at all times, and there is one angle where the front wheel and the rear wheel are in a parallel and coaxial state.

After the frame beam is folded through the two folding mechanisms, the three sections of the frame beam are all in a parallel state, and the frame beam is in a fully folded state.

The bicycle further includes a steering rod base and handlebar grips located on both sides of the steering rod base, where each of the handlebar grips includes a handlebar grip body and a handlebar grip base disposed at an end of the handlebar grip body, the steering rod base is provided with a mating base for hinged connection with the handlebar grip base, and the handlebar grip base is hingedly connected to the mating base, enabling the handlebar grip to be folded relative to the steering rod base; the bicycle further includes a folding locking mechanism, where the folding locking mechanism includes a lock pin base and reset members, a locking groove is formed in the mating base, a travel slide groove is formed in the handlebar grip base, and the lock pin base is movable along the travel slide groove and is resettable via the reset members; and when the lock pin base is snapped in the locking groove, the lock pin base is movable along the travel slide groove toward an outer end of the handlebar grip to achieve disengagement from the locking groove, thereby enabling the handlebar grip to be folded relative to the steering rod base.

A mating shaft hole is formed in the mating base, an articulated cavity is also formed in the mating base, a hinge shaft hole is formed in the handlebar grip base, the hinge shaft hole and the mating shaft hole are aligned and connected by a hinge shaft, the handlebar grip base is also provided with a hinge base mating with the articulated cavity, and the hinge base is accommodated in the articulated cavity and is rotatable along the articulated cavity.

The locking groove is located at an end of the mating base, and the locking groove is formed with a lateral opening.

Reset cavity grooves are also formed in the handlebar grip base; and one end of each of the reset members abuts against the lock pin base, and the other end thereof abuts against an interior of each of the reset cavity grooves.

The reset members are reset springs; and there are two reset members, there are two reset cavity grooves, and the two reset cavity grooves are respectively located on both sides of the travel slide groove.

A reset abutting groove is formed in the lock pin base.

The locking groove and the travel slide groove are located on the same horizontal plane.

The lock pin base includes a lock pin body and button portions located at both ends of the lock pin body; and the lock pin body penetrates the travel slide groove.

A sliding wall portion is disposed on each of the button portions, and the sliding wall portion is slidable along an outer side wall of the handlebar grip base.

A positioning groove is formed in a lower portion of the mating base, and the positioning groove is configured to mate with the lock pin body; and when the handlebar grip is in the folded state, an upper portion of the lock pin body is snapped in the positioning groove.

The rear wheel frame further includes a bottom bracket shell and a rear fork; and the rear fork is provided with a rear fork link, a rear wheel height adjustment mechanism is cooperatively arranged on the rear fork link, and the rear wheel height adjustment mechanism is configured to adjust a horizontal height of the rear wheel after the rear wheel is flipped and folded.

The rear wheel height adjustment mechanism includes an adjusting screw rod and a travel sleeve; the adjusting screw rod includes an abutting portion and an adjusting rod; and an end face of the abutting portion is configured to abut against a surface of the bottom bracket shell, and the adjusting rod penetrates the rear fork link and extends downwards.

The bicycle further includes a saddle storage portion, where the saddle storage portion is located on the rear wheel, a saddle assembly is cooperatively arranged on the seatpost fixing base on the rear wheel frame, and the saddle assembly and the seatpost fixing base are detachably connected; and when the frame beam is in a fully folded state, the saddle assembly is stored and mounted on the saddle storage portion after being detached.

Compared with the prior art, the present disclosure has the following beneficial effects: In the present disclosure, two hinges are disposed on the front half of the frame beam, and can be rotated and combined to form a parallel fold of the front wheel and the rear wheel, thereby enabling two-wheel pushing after folding; the loading platform structure is optimized, and a loading platform may formed by using the rotation of the loading platform after the bicycle is folded, which is convenient for use as an outdoor table; and after folding, the front wheel and the rear wheel may be kept coaxial, such that the volume after folding is minimal, various spaces are fully used, the structure is simple, and the folding operation is convenient, thereby allowing the folded bicycle to be pushed directly using the wheels themselves without the need for additional auxiliary wheels, improving user experience, and providing a good structural foundation for expanding other functions. Additionally, by optimizing the folding locking mechanism and combining the mating between the handlebar grip base and the mating base, the present disclosure enables the handlebar grip folding operation to be convenient and effective, and provides good stability in the use state, thereby facilitating user operation.

The characteristics of the present disclosure may be clearly understood by referring to the drawings and the detailed description of the preferred embodiments below.

### BRIEF DESCRIPTION OF THE DRAWINGS

FIG. 1 is a first schematic structural view of a folding bicycle in a folded state according to the present disclosure.

FIG. 2 is a second schematic structural view of a folding bicycle in a folded state according to the present disclosure.

FIG. 3 is a first schematic structural view of a folding bicycle in an unfolded state according to the present disclosure.

FIG. 4 is a third schematic structural view of a folding bicycle in a folded state according to the present disclosure.

FIG. 5 is a fourth schematic structural view of a folding bicycle in a folded state according to the present disclosure.

FIG. 6 is a second schematic structural view of a folding bicycle in an unfolded state according to the present disclosure.

FIG. 7 is a schematic structural view of handlebar grips and a steering rod base in a use state according to the present disclosure.

FIG. 8 is a schematic structural view of handlebar grips and a steering rod base in a folded state according to the present disclosure.

FIG. 9 is a schematic partially exploded structural view of handlebar grips and a steering rod base according to the present disclosure.

FIG. 10 is a schematic sectional structural view showing installation of handlebar grips and a steering rod base according to the present disclosure.

FIG. 11 is a schematic structural view of a handlebar grip base according to the present disclosure.

FIG. 12 is a schematic structural view of a lock pin base according to the present disclosure.

FIG. 13 is a first schematic structural view of a mating base according to the present disclosure.

FIG. 14 is a second schematic structural view of a mating base according to the present disclosure.

FIG. 15 is a schematic structural view showing installation of a rear wheel height adjustment mechanism according to the present disclosure.

FIG. 16 is a first schematic sectional view showing installation of a rear wheel height adjustment mechanism according to the present disclosure.

FIG. 17 is a second schematic sectional view showing installation of a rear wheel height adjustment mechanism according to the present disclosure.

FIG. 18 is a schematic structural view showing installation of a platform rack according to the present disclosure.

FIG. 19 is a first schematic reference view of use in a Z-shaped folded state according to the present disclosure.

FIG. 20 is a second schematic reference view of use in a Z-shaped folded state according to the present disclosure.

FIG. 21 is a third schematic reference view of use in a Z-shaped folded state according to the present disclosure.

FIG. 22 is a schematic reference view of a saddle storage portion and a saddle assembly in a stored state according to the present disclosure.

FIG. 23 is a schematic reference view of different folding states according to the present disclosure.

### DETAILED DESCRIPTIONS OF THE EMBODIMENTS

To make the technical means, creative features, achieved objectives, and effects of the present disclosure easy to understand, the present disclosure is further described below in conjunction with specific drawing.

### Embodiment 1

The bicycle product involved in the present disclosure is not limited to conventional bicycles; and the bicycle involved in the present disclosure may also include other two-wheeled vehicle products, such as electric bicycles, scooters, folding scooters, folding trolleys, and other two-wheeled vehicles with similar structures. To this end, the above vehicle specifications are all bicycle products as defined in the present disclosure.

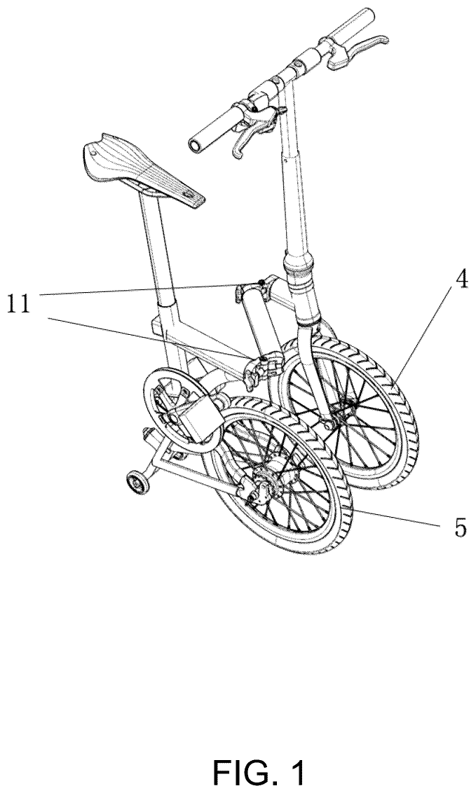

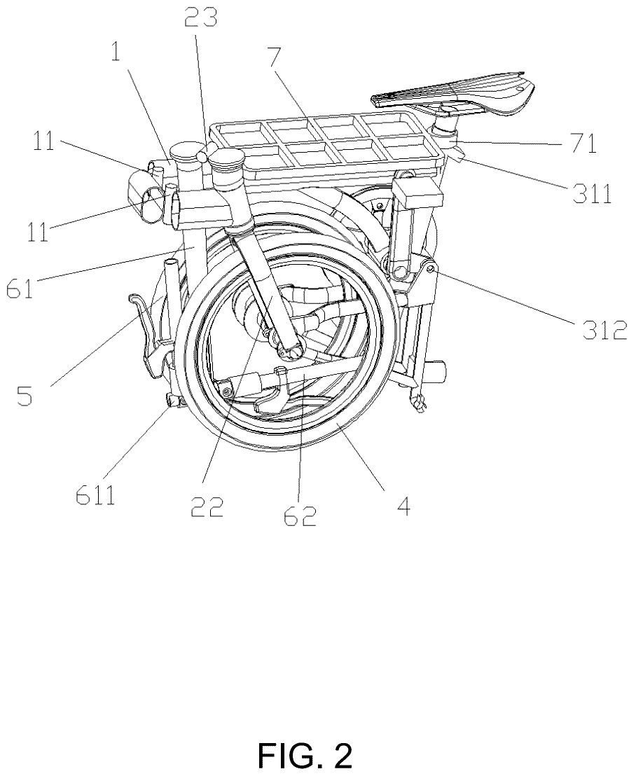

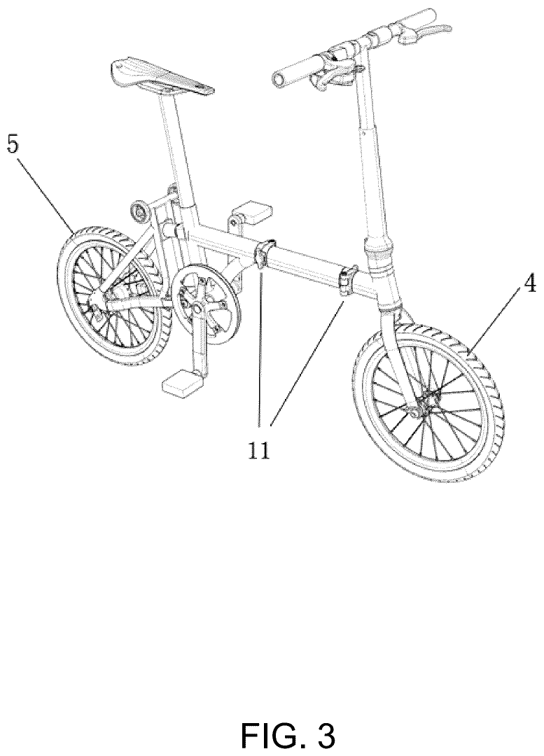

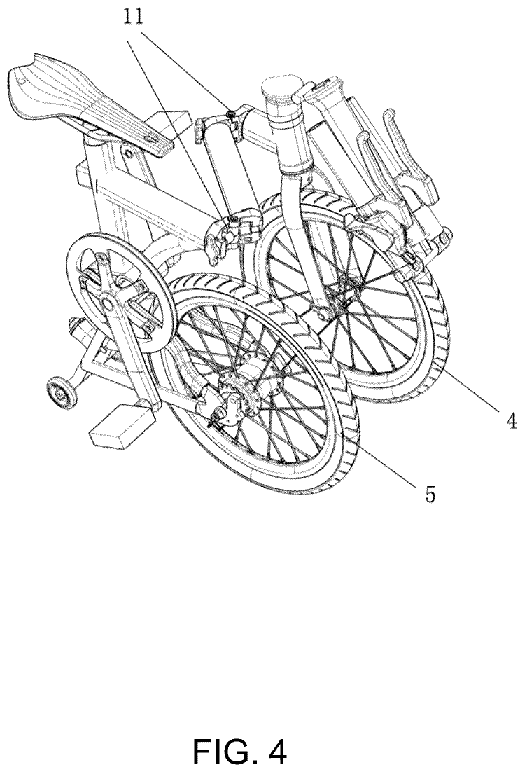

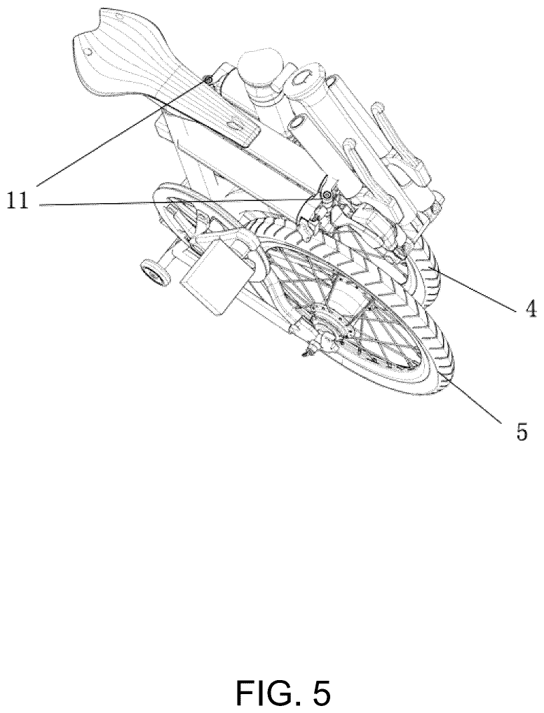

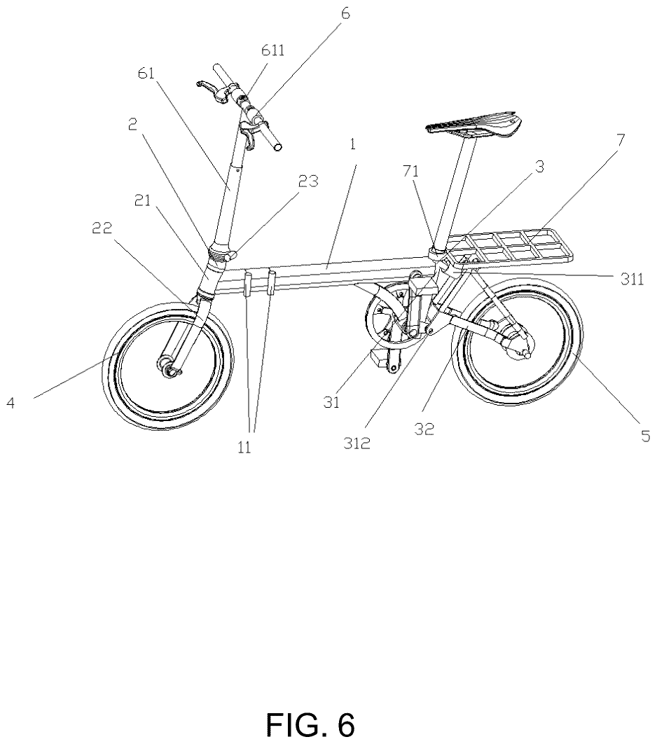

As shown in FIGS. 1 to 6, a folding bicycle of the present disclosure includes a frame beam 1, where the frame beam 1 connects a front wheel frame 2 and a rear wheel frame 3 at both ends, a front wheel 4 is mounted on the front wheel frame 2, and a rear wheel 5 is mounted on the rear wheel frame 3.

When the bicycle is fully unfolded and not folded, the frame beam 1 is generally straight, and the frame beam 1 is parallel to a line connecting a front wheel axle and a rear wheel axle, and also parallel to the ground.

The rear wheel frame 3 includes a seatpost fixing base 31 and a rear fork 32; the seatpost fixing base 31 is fixedly connected to a tail portion of the frame beam 1, and the rear wheel 5 is mounted on the rear fork 32; the seatpost fixing base 31 has a locking member 311 at an upper end, and has a hinge member 312 at a lower end; an upper end of the rear fork 32 is movably connected to the locking member 311 of the seatpost fixing base 31, and a lower end is hingedly connected to the hinge member 312 of the seatpost fixing base 31. When the rear wheel is not folded, the upper portion is tightly connected together by one locking member under the gravity of the bicycle itself and a rider. When the rear wheel is folded, the locking member 311 is manually unlocked, and the rear fork 32 is folded clockwise around the hinge member 312 downwards and forwards, thereby achieving a 180° forward flip of the entire rear wheel 5 and the rear fork 32 to a position in front of a bottom bracket. After the rear wheel 5 is flipped to the position in front of the seatpost fixing base 31, the rear wheel axle still lies above the line connecting the front wheel axle and the rear wheel axle before flipping.

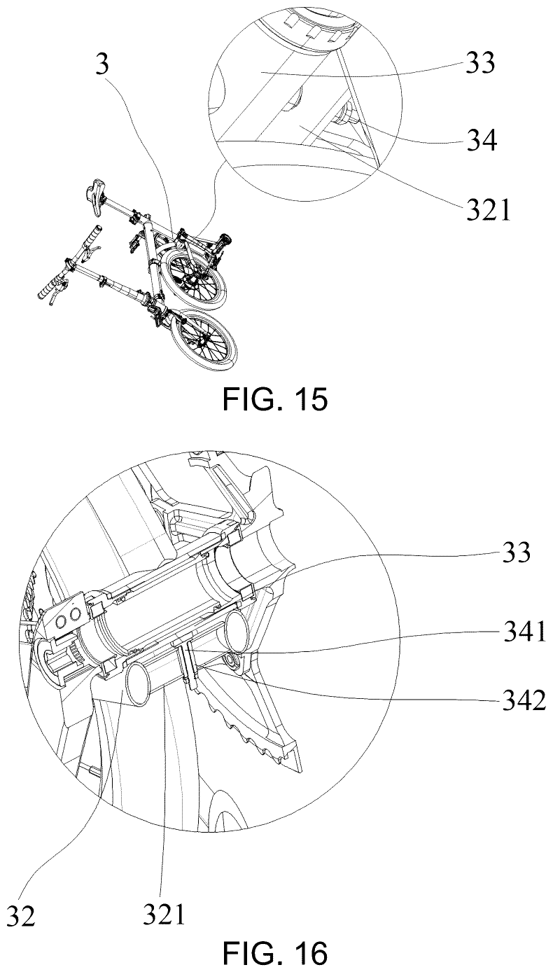

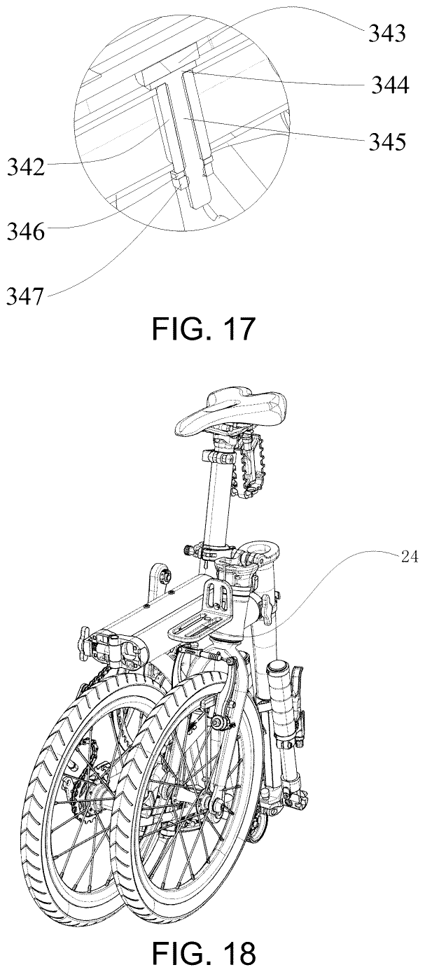

In conjunction with FIGS. 15 to 17, the rear wheel frame 3 further includes a bottom bracket shell 33 and a rear fork 32; and the rear fork 32 is provided with a rear fork link 321, a rear wheel height adjustment mechanism 34 is cooperatively arranged on the rear fork link 321, and the rear wheel height adjustment mechanism 34 is configured to adjust a horizontal height of the rear wheel after the rear wheel is flipped and folded. In a specific use process, the rear wheel height adjustment mechanism 34 can be used to fine-tune the height of the rear wheel. When the rear wheel is flipped forward and folded, in order to achieve a better state where the front wheel and the rear wheel are on the same horizontal plane, the rear wheel height adjustment mechanism is used to perform fine-tuning of the rear wheel, thereby improving the error tolerance rate.

In a specific structure, the rear wheel height adjustment mechanism 34 includes an adjusting screw rod 341 and a travel sleeve 342; the adjusting screw rod 341 includes an abutting portion 344 and an adjusting rod 345; one end face of the abutting portion 344 is configured to abut against a surface of the bottom bracket shell 33, and the adjusting rod 345 penetrates the rear fork link 321 and extends downwards; preferably, the adjusting screw rod 341 is T-shaped, and a rubber gasket 343 is arranged on an outer end face of the abutting portion 344 to increase abutting friction; the adjusting rod 345 penetrates the travel sleeve 342 and is threadedly connected to the travel sleeve 342, and the other end of the adjusting rod 345 extends to an outer end of the rear fork link 321, and is typically fitted with a washer 346 and a lock nut 347; and an outer end face of the adjusting rod 345 may be designed with a cross slot, a straight slot, or a hexagon socket to facilitate rotational adjustment of the adjusting rod.

The front wheel frame 2 includes a head tube 21 and a front fork 22; and the head tube 21 is fixedly connected to an end of the frame beam 1, the front fork 22 is threadedly and fixedly connected to the head tube 21, the front wheel 4 is fixedly connected to the front fork 22, and an upper portion of the head tube 21 is fixedly connected to the handlebar assembly 6. The handlebar assembly 6 includes a handlebar post 61 and a handlebar grip 62; and a lower end of the handlebar post 61 is foldably connected to the head tube 21 through a handlebar assembly folding mechanism 23, the handlebar post 61 can be folded downwards around the handlebar assembly folding mechanism 23, an upper end of the handlebar post 61 is fixedly connected to the handlebar grip 62, the handlebar grip 61 has a handlebar folding structure 611 at an end, and the handlebar grip 62 may be bent by 90°along the handlebar folding structure 611.

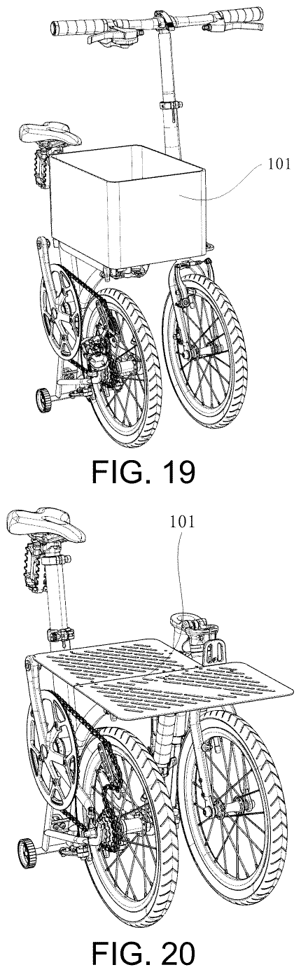

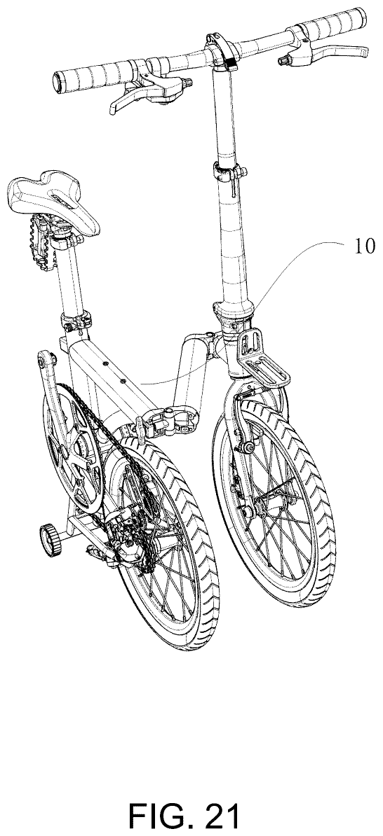

In conjunction with FIGS. 19 to 21 and the above, in a preferred state, when the frame beam is folded into a Z-shaped structure and the handlebar assembly 6 is in a downward folded state, an upper portion of the frame beam 1 forms a loading surface 10, and an upper portion of the loading surface 10 is configured to mate with a loading portion 101; and the loading surface 10 forms a horizontal plane, convenient for cooperating with the loading portion 101, and the loading portion 101 may be different items such as a basket, a storage box, and a loading platform, and may be matched according to usage requirements.

In conjunction with the above, there is another preferred state. According to user requirements, the handlebar assembly 6 may be used without folding down, and in an upright state, may be combined with a correspondingly applicable loading portion, such as a platform board, and it is convenient to use the handlebar assembly 6 as a pushing portion of a trolley, thereby facilitating user pushing.

In conjunction with the above and FIG. 18, a platform rack 24 is preferably disposed on the front wheel frame 2, and the platform rack 24 is configured to mate with the loading portion to improve the mounting stability of the loading portion.

Two folding mechanisms 11 are disposed on a front half of the frame beam 1 near the handlebar post 61. The folding mechanisms 11 may be of a general type currently available on the market, i.e., a mechanism with a vertical hinge on one side and an openable and closable structure on the other side. Moreover, hinges of the two folding mechanisms 11 are limiting hinges.

In conjunction with the above and FIG. 23, the folding mechanisms 11 employ limiting hinges, and the limiting hinges typically include a plurality of limiting states, thereby facilitating cooperation with the frame beam to achieve fixation in various folding states. For example, the hinge may have a limiting portion in a fully folded state, a limiting portion in a fully unfolded state, and a limiting portion in a Z-shaped folded state, thereby facilitating fixation after folding and improving stability in different states. In addition, in the Z-shaped folded state, according to different folding angles, corresponding limiting portions for the angles may be added accordingly to facilitate increasing folding functions.

### Embodiment 2

Based on Embodiment 1, in one this embodiment, the hinges of the two folding mechanisms 11 are both located on the same side of the frame beam 1 and are both perpendicular to the frame beam 1.

After the rear wheel 5 is flipped to the position in front of the seatpost fixing base 31, the handlebar grip 62 is folded by 90° along the handlebar folding structure 611, and then the handlebar post 61 is folded along the handlebar assembly folding mechanism 23 to a position below the same side as the folding mechanisms 11 and close to the front wheel 4.

After completing folding of the rear wheel and the handlebar assembly 6, the two folding mechanisms 11 of the frame beam 1 are opened, each is rotated by 90° horizontally along the hinge and limited in position, and finally the front wheel frame 2 and the front wheel 4 are rotated by 180° horizontally backward.

After the front wheel frame 2 and the front wheel 4 are rotated by 180°, the frame beam 1 forms a roughly U-shaped structure, a certain space is formed between both sides of the frame beam, and the folded-down handlebar post 61 is exactly located within this space.

After the front wheel frame 2 and the front wheel 4 are rotated by 180°, the front wheel 4 and the rear wheel 5 are parallel, and the front wheel 4 and the rear wheel 5 may be in a coaxial position.

After the front wheel frame 2 and the front wheel 4 are rotated by 180°, the axles of the front wheel 4 and the rear wheel 5 are close together, and a folding angle is fixed by the limiting hinges. In this way, by holding the saddle of the bicycle, the bicycle can be pushed directly relying on the front wheel 4 and the rear wheel 5, without the need for additionally installed auxiliary wheels.

### Embodiment 3

In conjunction with Embodiment 1, this embodiment is a preferred embodiment. In this embodiment, one of the two folding mechanisms 11 is disposed on one side of a front portion of the frame beam 1, and the other is disposed on the other side of a rear portion of the frame beam 1. After the rear wheel 5 is flipped to the position in front of the seatpost fixing base 31, the handlebar grip 62 is folded by 90° along the handlebar folding structure 611, and then the handlebar post 61 is folded along the handlebar assembly folding mechanism 23 to a position below the same side as the folding mechanisms 11 and close to the front wheel 4. After folding, the handlebar grip 62 may be tilted directly forward or backward relative to the head tube, thereby reducing the folding thickness.

After completing folding of the rear wheel and the handlebar assembly 6, one folding mechanism 11 is rotated horizontally backward, and then the other folding mechanism 11 is rotated horizontally forward in an opposite direction. The frame beam 1 forms a Z-shaped structure after being folded through the two folding mechanisms 11, and by adjusting the folding angle, the front wheel 4 and the rear wheel 5 are brought into a parallel state.

By adjusting the folding angle after the frame beam 1 is folded through the two folding mechanisms 11, a distance between the front wheel and the rear wheel may be adjusted. In conjunction with our implementation solution, regarding the design structure of the overall frame of the folding bicycle, this design may be applied to bicycles of different specifications and dimensions. By adjusting the positions of the two folding mechanisms 11 on the frame beam 1, the relative positions of the front wheel and the rear wheel after the folding bicycle is completely folded may be adjusted, thereby enabling overall dimension minimization when the bicycle is fully folded. For example, using a correspondingly preferred design of the positions of the folding mechanisms 11, the front wheel and the rear wheel may be in a staggered position after folding, such that the protruding axle positions of the front wheel and the rear wheel are arranged in a staggered manner, thereby achieving optimized processing of the folded thickness dimension.

In a specific structure, one folding mechanism 11 is rotated horizontally backward by 180°, and then the other folding mechanism 11 is rotated horizontally forward by 180° in an opposite direction, such that three sections of the frame beam 1 are all in a parallel state, and the frame beam 1 is in a fully folded state.

After the front wheel frame 2 and the front wheel 4 are folded, and the front wheel 4 and the rear wheel 5 are in a parallel state, the folding angle is then fixed by limiting hinges or other locking mechanisms. In this way, by holding the saddle of the bicycle, the bicycle can be pushed directly relying on the front wheel 4 and the rear wheel 5, without the need for additionally installed auxiliary wheels; and in the folded state of the frame beam, the front wheel and the rear wheel can always be kept parallel and at the same height, such that the overall bicycle has the function of being pushed directly relying on its own wheels, without the need for auxiliary small wheels or other mechanisms.

When the bicycle is unfolded, a loading platform 7 may be disposed on the seatpost fixing base 31, the loading platform 7 is mounted horizontally through a steering shaft sleeve 71 below the seatpost clamp, and the steering shaft sleeve 71 may rotate horizontally. When the bicycle is folded, the loading platform 7 may be rotated by 180° through the steering shaft sleeve 71 and placed on the upper portion of the frame beam 1, thereby forming a loading platform for the bicycle when used as a trolley.

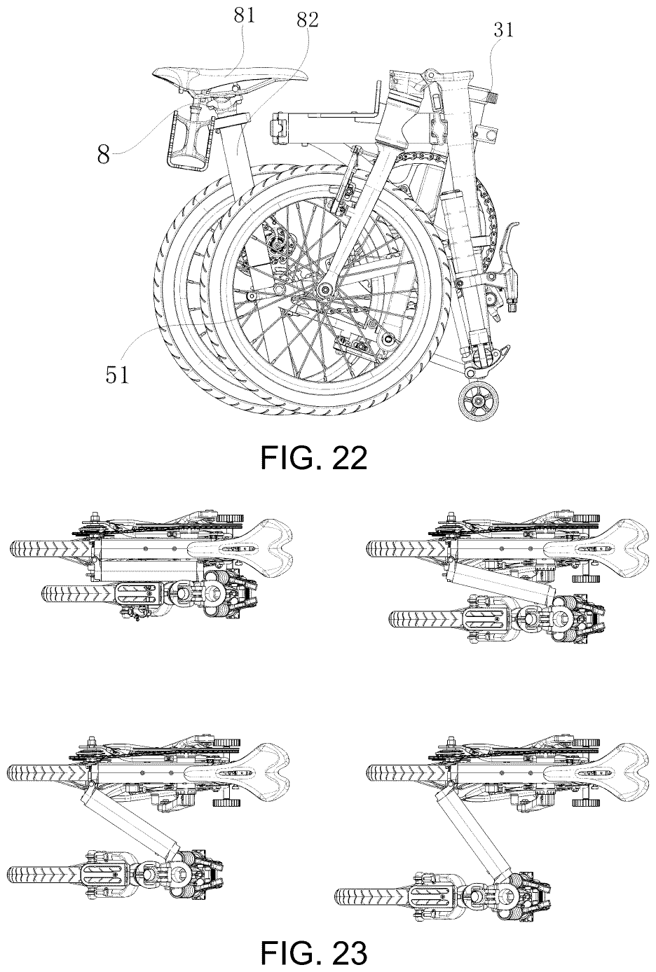

In one preferred embodiment, in conjunction with FIG. 22, the bicycle further includes a saddle storage portion 51, where the saddle storage portion 51 is located on the rear wheel 5, and the saddle storage portion 51 is typically a component such as a clamp or a snap ring, preferably cooperatively arranged on the axle of the rear wheel 5. A saddle assembly 8 is cooperatively arranged on the seatpost fixing base 31 on the rear wheel frame 3, and the saddle assembly 8 and the seatpost fixing base 31 are detachably connected. The saddle assembly 8 typically includes a saddle body 81 and a saddle sleeve 82 located at a lower portion of the saddle body 81; and a lower end of the saddle sleeve 82 is retractable and fitted to the seatpost fixing base 31, and may also be withdrawn as a whole. When the frame beam 1 is in a fully folded state, the saddle assembly 8 is stored and mounted on the saddle storage portion 51 after being detached. The specific structure is such that a lower portion of the saddle sleeve 82 is snapped and fixed to the saddle storage portion 51. The saddle storage portion 51 is usually located in a gap between the front wheel 4 and the rear wheel 5 after folding, such that the saddle assembly 8 is stored entirely in this area, thereby improving storage space utilization, and further reducing the folded volume and enhancing the overall folding effect in terms of dimensions.

### Embodiment 4

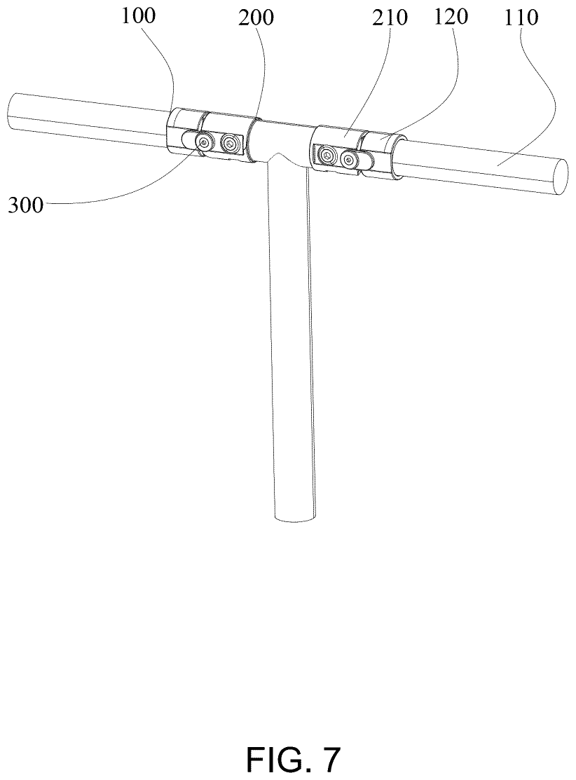

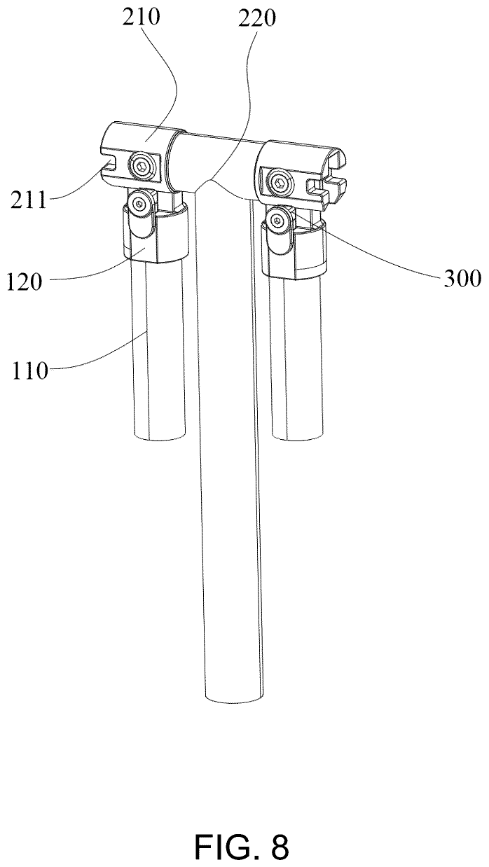

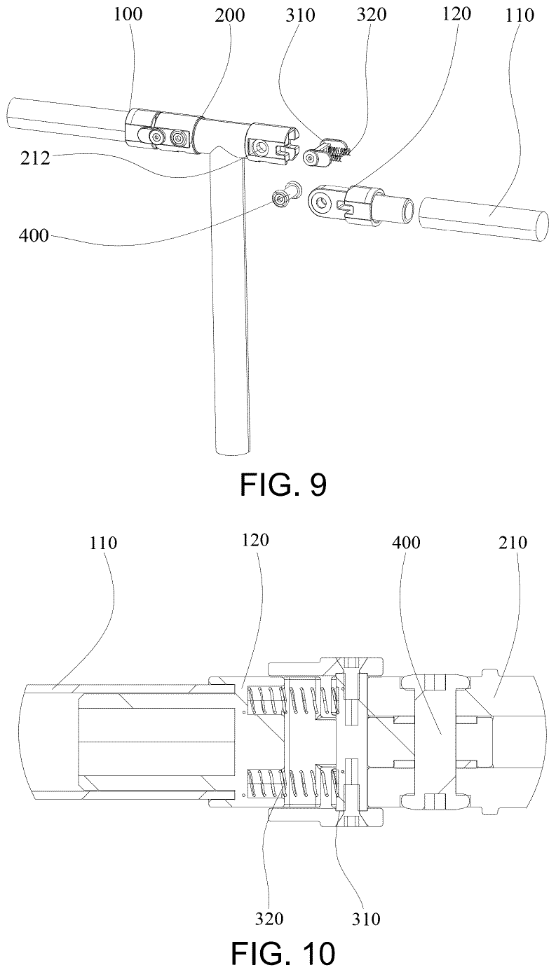

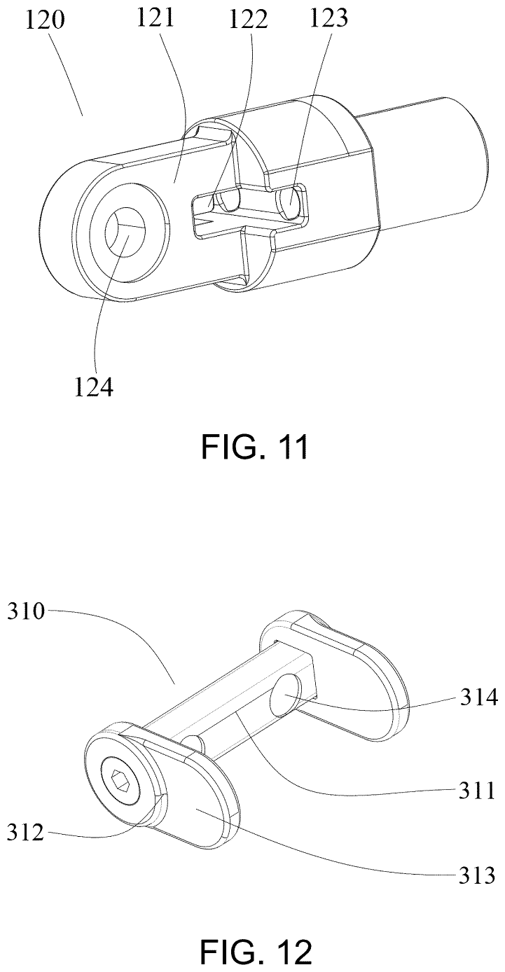

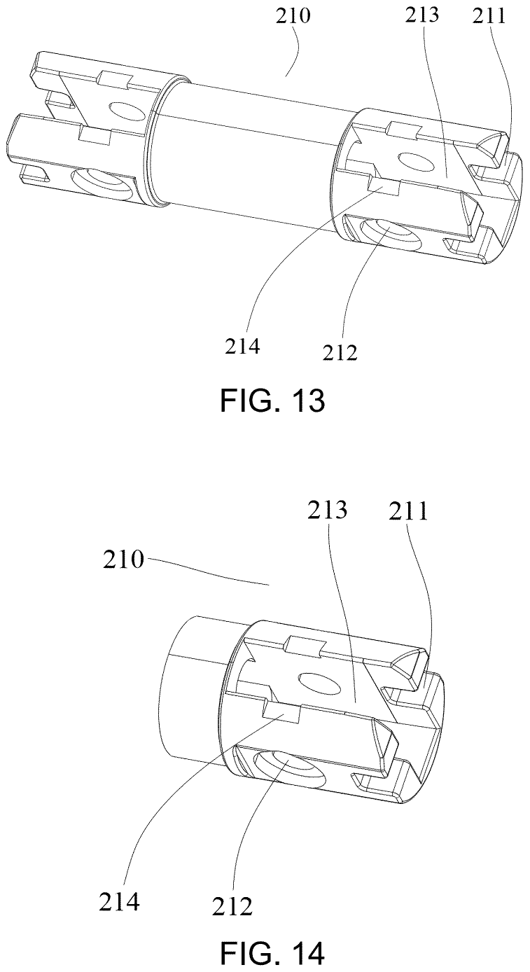

Based on any one of the above embodiments, in conjunction with FIGS. 7 to 14, this embodiment discloses a folding handlebar assembly for a folding bicycle, including a steering rod base 200 and handlebar grips 100 located on both sides of the steering rod base 200, where a lower portion of the steering rod base 200 is connected to a front frame. Typically, the vehicle is preferably a bicycle, but may also be a related vehicle such as an electric vehicle, an electric bicycle, a tricycle, a scooter, and a trolley. This structure may be applied to various vehicle models of different specifications and is not limited to the above vehicles.

In a specific structure, each of the handlebar grips 100 includes a handlebar grip body 110 and a handlebar grip base 120 disposed at an end of the handlebar grip body 110. The handlebar grip body 110 may have various shapes and specifications according to usage requirements. The steering rod base 200 is provided with mating bases 210 for hinged connection with the handlebar grip bases 120. The mating bases 210 are typically disposed at both ends, with a middle portion integrally connectable, or respectively fixed to both ends of a steering rod base body 220. The handlebar grip base 120 is hingedly connected to the mating base 210, and typically, a hinge shaft 400 is cooperatively arranged to achieve hinged movement, such that the handlebar grip 100 can be folded relative to the steering rod base 200. In a specific embodiment, the handlebar grip is typically folded downwards to form a parallel arrangement with a lower rod body of the steering rod base 200, thereby achieving a reduction in the lateral dimension. In a specific structure, a mating shaft hole 211 is formed in the mating base 210, an articulated cavity 213 is also formed in the mating base 210, a hinge shaft hole 124 is formed in the handlebar grip base 120, the hinge shaft hole 124 and the mating shaft hole 121 are aligned and connected by a hinge shaft 400, the handlebar grip base 120 is also provided with a hinge base 121 mating with the articulated cavity 213, and the hinge base 121 is accommodated in the articulated cavity 213, which may be partially or fully accommodated depending on the position, and is rotatable along the articulated cavity 213.

In conjunction with the above, a folding locking mechanism 300 is preferably designed. The folding locking mechanism 300 includes a lock pin base 310 and reset members 320, a locking groove 211 is formed in the mating base 210, a travel slide groove 122 is formed in the handlebar grip base 120, and the lock pin base 310 is movable along the travel slide groove 122 and is resettable via the reset members 320. When the lock pin base 310 is snapped in the locking groove 211, and the lock pin base 310 is movable along the travel slide groove 122 toward an outer end of the handlebar grip 100 to achieve disengagement from the locking groove 211, thereby enabling the handlebar grip 100 to be folded relative to the steering rod base 200. The movement of the lock pin base 310 is optimized to achieve locking or unlocking of the handlebar grip 100 and the steering rod base 200, which has the characteristics of convenient unlocking operation and stable locking, and after unlocking, the folded state is stable, and rebound is prevented.

Preferably, the locking groove 211 is located at an end of the mating base 210, and the locking groove 211 is formed with a lateral opening. The locking groove 211 and the travel slide groove 122 are located on the same horizontal plane, thereby facilitating sliding of the lock pin base 310. Specifically, the lock pin base 310 includes a lock pin body 311 and button portions 312 located at both ends of the lock pin body 311; and the lock pin body 311 penetrates the travel slide groove 122, a sliding wall portion 313 is disposed on each of the button portions 312, and the sliding wall portion 313 is slidable along an outer side wall of the handlebar grip base 120.

In specific use, when folding and unlocking are required, a user presses the button portion 312 and slides the button portion 312 laterally outward in parallel, causing the lock pin body 311 to slide along the travel slide groove 122; and the lock pin body 311 disengages from the locking groove 211, thereby completing the unlocking. Then, the user deflects the handlebar grip body 110 downwards, causing the handlebar grip base 120 to rotate relative to the mating base 210, move down and deflect along the articulated cavity 213, thereby completing the folding operation. Specifically, the button portions 312 are preferably disposed on both sides, and the user may slide the button portions 312 by clamping the button portions 312 on both sides, or may slide the button portion on a single side. The sliding wall portion 313 is preferably arranged to increase sliding smoothness.

In conjunction with the above, in a specific structure, reset cavity grooves 123 are also formed in the handlebar grip base 120; and one end of each of the reset members 320 abuts against the lock pin base 310, and the other end thereof abuts against an interior of each of the reset cavity grooves 123. Specifically, a reset abutting groove 314 is formed in the lock pin base 310, and the reset abutting groove 314 and the reset cavity grooves 123 are oppositely arranged, thereby facilitating the abutting of the reset members 320. Preferably, the reset members 320 are reset springs; and there are two reset members 320, there are two reset cavity grooves 123, and the two reset cavity grooves 123 are respectively located on both sides of the travel slide groove 122. A positioning groove 214 is formed in a lower portion of the mating base 210, and the positioning groove 214 is configured to mate with the lock pin body 311. When the handlebar grip 100 is in the folded state, an upper portion of the lock pin body 311 is snapped in the positioning groove 214.

The above structure is optimized. The lock pin body 311 may be snapped in the positioning groove 214, thereby preventing the handlebar grip 100 from rebounding in the folded state, and increasing the stability of the folded state. The arrangement structure of the reset members 320 is optimized. After the handlebar grip 100 is folded, the reset members 320 may be used to increase locking abutment between the lock pin body 311 and the positioning groove 214, thereby increasing the stability in the folded state.

By optimizing the folding locking mechanism and combining the mating between the handlebar grip base and the mating base, the present disclosure enables the handlebar grip folding operation to be convenient and effective, and provides good stability in the use state, thereby facilitating user operation.

The above descriptions are only preferred embodiments of the present disclosure and are not intended to limit the present disclosure in any form. Any simple modifications, equivalent variations, or alterations made to the above embodiments based on the technical principles of the present disclosure still fall within the scope of the technical solution of the present disclosure.

What is claimed is:

1. A folding bicycle, comprising a frame beam, the frame beam connecting a front wheel frame and a rear wheel frame at both ends, a front wheel being mounted on the front wheel frame, and a rear wheel being mounted on the rear wheel frame, wherein two folding mechanisms are disposed on the frame beam, and the frame beam is configured to be folded into three sections through the two folding mechanisms; when the rear wheel frame drives the rear wheel to flip vertically forward, the frame beam is folded through the folding mechanisms, and by adjusting a folding angle, the front wheel and the rear wheel are brought into a parallel state; one of the two folding mechanisms is disposed on one side of a front portion of the frame beam, and the other is disposed on the other side of a rear portion of the frame beam; and the frame beam forms a Z-shaped structure after being folded through the two folding mechanisms, and by adjusting the folding angle, the front wheel and the rear wheel are brought into a parallel state.

2. The folding bicycle according to claim 1, wherein a loading platform is disposed on the rear wheel frame, the loading platform is mounted cooperatively with a seatpost fixing base through a steering shaft sleeve, and the loading platform is rotatable through the steering shaft sleeve.

3. The folding bicycle according to claim 1, wherein hinges of the two folding mechanisms are limiting hinges.

4. The folding bicycle according to claim 1, wherein by adjusting the folding angle after the frame beam is folded through the two folding mechanisms, a distance between the front wheel and the rear wheel is adjusted.

5. The folding bicycle according to claim 1, wherein after the frame beam is folded through the two folding mechanisms, the three sections of the frame beam are all in a parallel state, and the frame beam is in a fully folded state.

6. The folding bicycle according to claim 1, wherein when the frame beam is folded into the Z-shaped structure, an upper portion of the frame beam forms a loading surface, and an upper portion of the loading surface is configured to mate with a loading portion.

7. The folding bicycle according to claim 6, wherein a platform rack is also disposed on the front wheel frame.

8. The folding bicycle according to claim 1, further comprising a steering rod base and handlebar grips located on both sides of the steering rod base, wherein each of the handlebar grips comprises a handlebar grip body and a handlebar grip base disposed at an end of the handlebar grip body, the steering rod base is provided with a mating base for hinged connection with the handlebar grip base, and the handlebar grip base is hingedly connected to the mating base, enabling the handlebar grip to be folded relative to the steering rod base; and further comprising a folding locking mechanism, wherein the folding locking mechanism comprises a lock pin base and reset members, a locking groove is formed in the mating base, a travel slide groove is formed in the handlebar grip base, and the lock pin base is movable along the travel slide groove and is resettable via the reset members; and when the lock pin base is snapped in the locking groove, the lock pin base is movable along the travel slide groove toward an outer end of the handlebar grip to achieve disengagement from the locking groove, thereby enabling the handlebar grip to be folded relative to the steering rod base.

9. The folding bicycle according to claim 8, wherein a mating shaft hole is formed in the mating base, an articulated cavity is also formed in the mating base, a hinge shaft hole is formed in the handlebar grip base, the hinge shaft hole and the mating shaft hole are aligned and connected by a hinge shaft, the handlebar grip base is also provided with a hinge base mating with the articulated cavity, and the hinge base is accommodated in the articulated cavity and is rotatable along the articulated cavity.

10. The folding bicycle according to claim 9, wherein the locking groove is located at an end of the mating base, and the locking groove is formed with a lateral opening.

11. The folding bicycle according to claim 8, wherein reset cavity grooves are also formed in the handlebar grip base; and one end of each of the reset members abuts against the lock pin base, and the other end thereof abuts against an interior of each of the reset cavity grooves.

12. The folding bicycle according to claim 11, wherein the reset members are reset springs; and there are two reset members, there are two reset cavity grooves, and the two reset cavity grooves are respectively located on both sides of the travel slide groove.

13. The folding bicycle according to claim 11, wherein a reset abutting groove is formed in the lock pin base.

14. The folding bicycle according to claim 13, wherein the locking groove and the travel slide groove are located on the same horizontal plane.

15. The folding bicycle according to claim 14, wherein the lock pin base comprises a lock pin body and button portions located at both ends of the lock pin body; and the lock pin body penetrates the travel slide groove.

16. The folding bicycle according to claim 15, wherein a sliding wall portion is disposed on each of the button portions, and the sliding wall portion is slidable along an outer side wall of the handlebar grip base.

17. The folding bicycle according to claim 16, wherein a positioning groove is formed in a lower portion of the mating base, and the positioning groove is configured to mate with the lock pin body; and when the handlebar grip is in a folded state, an upper portion of the lock pin body is snapped in the positioning groove.

18. The folding bicycle according to claim 1, wherein the rear wheel frame further comprises a bottom bracket shell and a rear fork; and the rear fork is provided with a rear fork link, a rear wheel height adjustment mechanism is cooperatively arranged on the rear fork link, and the rear wheel height adjustment mechanism is configured to adjust a horizontal height of the rear wheel after the rear wheel is flipped and folded.

19. The folding bicycle according to claim 18, wherein the rear wheel height adjustment mechanism comprises an adjusting screw rod and a travel sleeve; the adjusting screw rod comprises an abutting portion and an adjusting rod; and an end face of the abutting portion is configured to abut against a surface of the bottom bracket shell, and the adjusting rod penetrates the rear fork link and extends downwards.

20. The folding bicycle according to claim 2, further comprising a saddle storage portion, wherein the saddle storage portion is located on the rear wheel, a saddle assembly is cooperatively arranged on the seatpost fixing base on the rear wheel frame, and the saddle assembly and the seatpost fixing base are detachably connected; and when the frame beam is in a fully folded state, the saddle assembly is stored and mounted on the saddle storage portion after being detached.
